(19) United States
(12) Patent Application Publication
(10) Pub. No.: US 2003/0005813 A1
(43) Pub. Date: Jan. 9, 2003

(54) Packaging and dispensing device for musical instrument strings

(75) Inventor: Sergio E. Villanueva, San Ysidro, CA (US)

Correspondence Address: SNELL & WILMER, ONE ARIZONA CENTER, 400 EAST VAN BUREN, PHOENIX, AZ, 850040001

(73) Assignee: Fender Musical Instruments Corporation, Scottsdale, AZ (US)

(21) Appl. No.: 10/187,649

(22) Filed: Jul. 2, 2002

Related U.S. Application Data
(60) Provisional application No. 60/303,029, filed on Jul. 3, 2001.

(51) Int. Cl. G10G 1/00

(52) U.S. Cl. 84/453

(57) ABSTRACT

A packaging device for musical instrument strings provides for easy identification and dispensing of individual strings without bending, curling or tangling the strings. Each string is individually wound on its own string carrier such that the string can be individually removed without disturbing the remaining strings. In one embodiment, a base and cover enclose a series of string carriers with each string carrier having a channel holding a coiled string. The various string carriers may be stacked together and enclosed by an external housing such that the string carriers are allowed to individually rotate, or the carriers may remain fixed with respect to each other and to the package housing. The package may be formed of thermoformed plastic, injection molded plastic, cardboard, or any other material. The dispenser may be used to package strings for guitars, pianos, harps or any other stringed instrument.

This Application claims priority of U.S. Provisional Patent Application Serial No. 60/303,029 filed on Jul. 3, 2001 and incorporated herein by reference.

### FIELD OF INVENTION

The invention relates generally to packaging and dispensing strings for musical instruments. More particularly, various embodiments relate to a unique string dispenser for storing multiple musical instrument strings, such as guitar strings.

### BACKGROUND OF THE INVENTION

Stringed musical instruments such as electric and acoustic guitars, mandolins, violins, banjos, pianos, harps and the like are played by millions of musicians throughout the world. Conventional guitars, for example, typically include six strings of varying diameter that vibrate to create tones of varying pitch. To produce musical notes, the musician typically plucks one or more strings with one hand while simultaneously controlling the length of a vibrating portion of the string with the other hand. The length of the vibrating portion may be adjusted by, for example, pressing a portion of the string against a fretboard or other surface with one or more fingers. By shortening or lengthening the vibrating portion of the string, the pitch can be made respectively higher or lower as appropriate. Examples of strings and manufacturing techniques used in making strings are described in U.S. Pat. No. 5,913,257.

The strings used on musical instruments eventually degrade due to the effects of use, wear, age, and environmental conditions. As the strings wear, the tone or timbre of the string typically degrades, and breakage may become more likely. It is therefore necessary for the musician to replace the strings on occasion. String replacement frequency varies widely depending upon the individual tastes and requirements of the musician. Professional musicians often change strings every day, whereas casual musicians may change the instrument strings as rarely as one or two times each year. Various manufacturers of guitar strings (including the Fender Musical Instruments Corporation of Scottsdale, Ariz.) provide replacement strings for guitars and other instruments that are widely available at conventional retail outlets.

A set of strings is typically packaged for sale by rolling each string into a coil of approximately 4-6 inches in diameter. Generally, each string is marked with a label or color-tab to indicate the diameter of the string and/or its suggested position on the instrument. To keep the string from becoming uncoiled, either or both ends of the string are typically passed through the coil to lock the coil in place. Each coiled string may then be individually packaged in its own envelope. The coiled strings may then be packaged together in a paper or cardboard box, a plastic envelope or another package for shipment and sale.

There are, however, several disadvantages associated with conventional string packaging techniques. In particular, conventionally-packaged strings often become entangled with each other, making it difficult to remove a desired string from the package. Frequently, all strings must be removed from the package when only one string may be desired at a particular time. Further, conventional packaging requires that the musician use care when extracting the string from the package, unlocking the ends and uncoiling the string, as strings can often become kinked, bent or otherwise damaged during the unpacking process. Moreover, the coiled string typically possesses a potential energy that can readily be converted to kinetic energy when the string is unlocked. This kinetic energy can cause the string to snap or uncoil very quickly, potentially creating a scratch or cut on exposed skin if the user is careless.

It is therefore desirable to create a new device and technique for packaging strings for musical instruments. Such a technique should be easy to implement in a reasonably-priced manner, and the resulting device should be sized to fit in existing string display space at retail sites. Most importantly, the packaging should protect the strings from binding, kinking or tangling during storage or removal from the package.

### SUMMARY OF THE INVENTION

The present invention provides a new packaging device and technique that overcomes the various disadvantages of conventional string packaging. Various embodiments of the present invention provide a string package wherein each string is provided on its own string carrier such that the string may be individually removed without affecting the remaining strings. In one embodiment, a base and cover enclose a series of string carriers, one carrier for each string. The string carrier is appropriately formed with a channel for receiving the coiled string; the string may alternatively be wound about the carrier, or otherwise positioned on the carrier. In one embodiment, the various string carriers may be stacked together and enclosed by an external housing such that the carriers are allowed to individually rotate. Alternatively, the string carriers are fixedly held by the housing such that the strings are unwound from the carrier by a force exerted by the user. The package may be formed of thermoformed plastic, injection molded plastic, cardboard, or any other material. After one or more strings are dispensed from the package, they may be mounted on a musical instrument as appropriate.

### BRIEF DESCRIPTION OF THE DRAWING FIGURES

The features and advantages of the present invention are hereinafter described in the following detailed description of exemplary embodiments to be read in conjunction with the accompanying drawing figures, wherein like reference numerals are used to identify the same or similar parts in the similar views, and:

FIGS. 1A and 1B are top and side views of an exemplary string packaging device;

FIGS. 2A-C are front, side and cutaway views of an exemplary string carrier for use in a string packaging device;

FIGS. 3A-J are various views of an exemplary string packaging device, having rotating string carriers, and the various components thereof;

FIGS. 4A-D are top, side, perspective and exploded perspective views, respectively, of another exemplary string packaging device;

FIG. 5 is a cutaway perspective view of an exemplary string packaging device as shown in FIGS. 4A-C; and

FIG. 6 is a cutaway perspective view of another exemplary string packaging device.

### DETAILED DESCRIPTION OF EXEMPLARY EMBODIMENTS

According to various embodiments of the invention, a new and unique string dispenser and packaging device is provided. The dispenser allows each string to be individually wound and isolated from other strings provided in the package. Each string is appropriately wound on an individual string carrier that is enclosed within a housing. To remove a particular string, the user simply pulls on an end of the string to uncoil the string from the carrier. In a further embodiment, the string carriers may be configured to individually rotate with respect to each other and/or the housing to aid in dispensing the string. Accordingly, the new dispenser/packaging device simplifies the dispensing of a string while lessening the chances of string tangling, bending or kinking. Further, the dispenser allows users to remove a desired string from the package without disturbing the other strings. The dispenser may be readily formed from thermoformed or injected molded plastic, cardboard, metal or any other material. As used herein, the terms “string packaging device”, “string package” and “string dispenser” are synonymous.

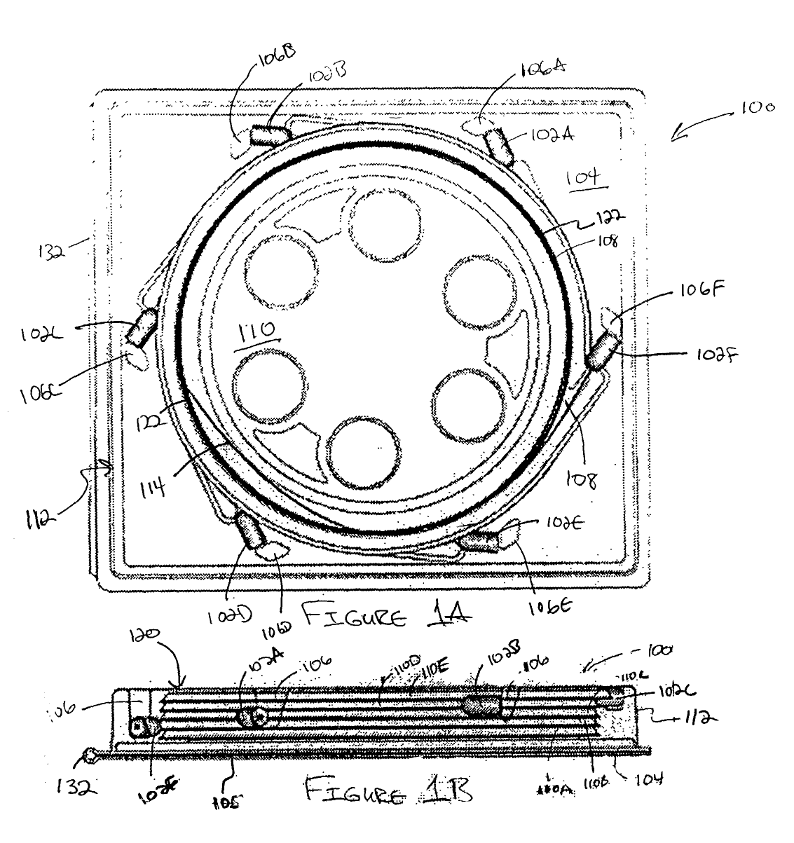

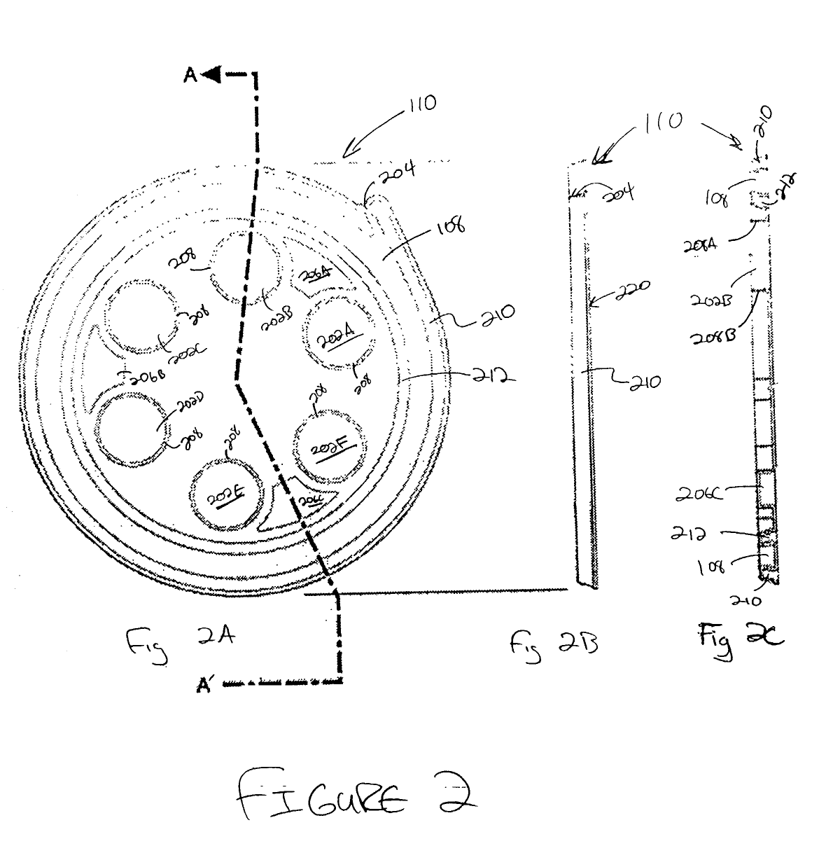

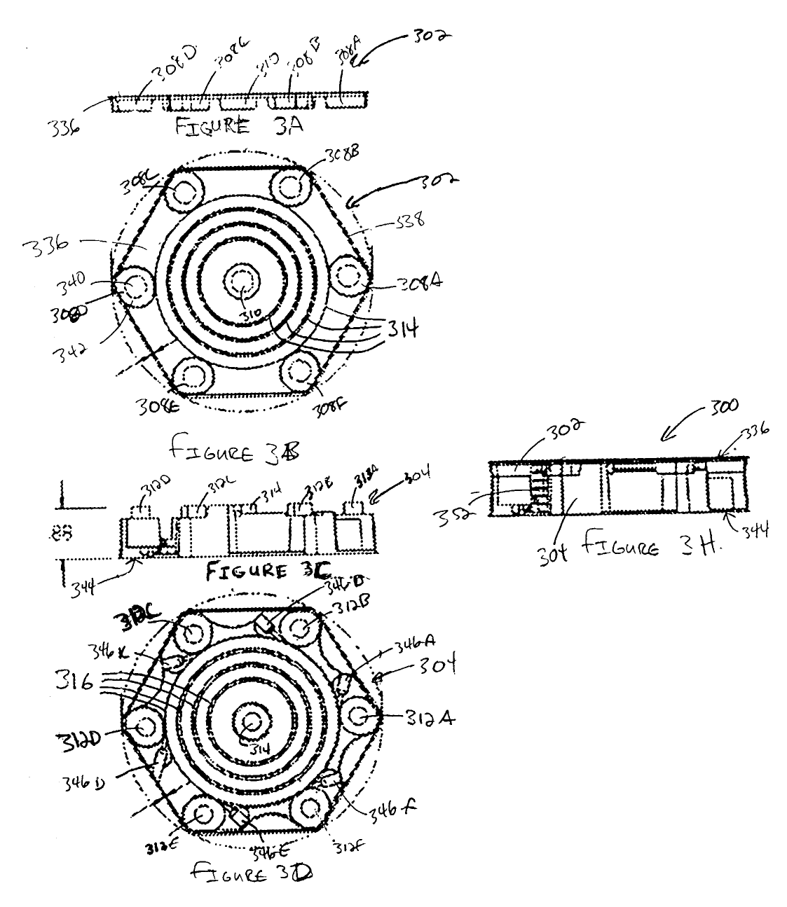

FIGS. 1A and 1B are top and side views, respectively, of an exemplary string packaging device. With reference now to FIGS. 1A and 1B, an exemplary string packaging device/dispenser 100 suitably includes a housing 104 enclosing a number of string carriers 110A-E. Each carrier 110A-E is a spool, spiral tube, disk, cylinder, reel or other structure that holds a single string 102A-F as appropriate. String 102 is wound within a channel 108 of string carrier 110, and a post 106A-F formed on housing 104 holds the end of string 102 in place, as shown.

Housing 104 suitably includes a base 112 and a cover 105 as appropriate. Each part of housing 104 is formed to house string carriers 110A-E which store and dispense a coiled string 102. Posts 106A-F are may be any type of block or outcropping on housing 104 capable of holding the ends of strings 102A-F in place. In the embodiment shown in FIGS. 1A-1B, base 112 suitably includes six posts 106A-F positioned at approximately 60 degrees intervals on base 112. The length of each post 106A-F may be varied to receive a particular string 102A-F, recognizing that each string carrier 110A-E is at a unique distance from top face 120 of package 100. Accordingly, the relatively wide (i.e. “ball”) ends of each string 102A-F may be staggered at a sixty-degree or other appropriate angle such that the width of package 100 is reduced. Cover 105 suitably holds string carriers 110A-E in position against base 112, and may be affixed to base 112 with an epoxy, adhesive, glue or the like. Alternatively, base 112 and cover 105 may be coupled to each other with an optional hinge 132 in a “clamshell” configuration, with a mechanical or with any other lock, joining technique. In an exemplary embodiment, string package/dispenser 100 has dimensions of approximately 4″×4.375″×0.5″, although of course these dimensions will vary widely from embodiment to embodiment.

In operation, each string 102A-F is suitably wound inside channel 108 on a string carrier 110A-E. In some embodiments, one or more string carriers 110 may be integrally formed within housing 104 such that a separate carrier 110 for one or more strings 102 may not be required. In a further embodiment, a narrow end 114 of string 102 is inserted into a hole or gap in channel 108 such that the string 102 is held in place by friction or the like. String carrier 110 may then be rotated or otherwise wound to draw the body of string 102 into channel 108 and to form a coil 122 therein. When the body of string 102 is completely wound, the remaining end is held in place by post 106 which holds the end of string 102 against the mouth of channel 108 such that string 102 remains in place during shipment. Alternatively, post 106 includes a notch or groove to receive the end of string 102. Each wound carrier 110 containing a string 102 is then placed within housing 104 with the other string carriers 110 as appropriate. When all strings 102 are properly wound and positioned on string carriers 110 and placed within housing 104, the housing may be sealed with adhesive, shrinkwrap, a mechanical lock, or any other sealing technique.

To remove a string 102 from package 100, a user simply pulls on the end of the string after removing the end from post 106. The particular string 102 suitably unwinds around string carrier 110 to dispense the string. As the desired string 102 is being dispensed from package 100, the other strings 102 are maintained within package 100. Accordingly, the strings 102 remain individually packaged such that the likelihood of tangling, kinking or bending the strings 102 during removal from package 100 is dramatically reduced. Moreover, each string 102 is individually identifiable to the user before the package is opened, thus allowing for extraction of a single desired string 102 without disturbing the packaging of the other strings.

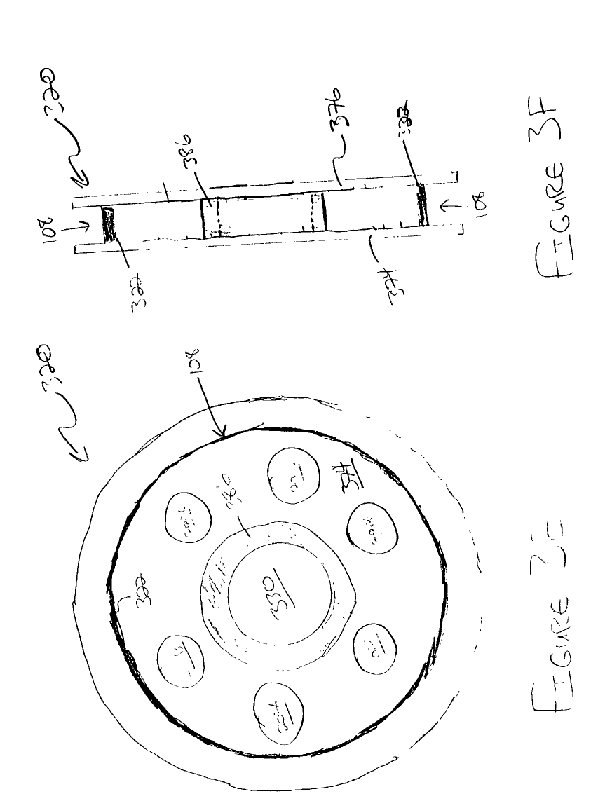

FIGS. 2A-C are front, side and cutaway views, respectively, of an exemplary string carrier suitable for use with the string dispenser shown in FIG. 1, with FIG. 2C being a cutaway along line A-A′ in FIG. 2A. With reference now to FIGS. 2A-C, an exemplary string carrier 110 suitably includes a channel 108 formed between an outer flange 210 and an inner flange 212. One or more optional holes 202A-F may be provided, as may one or more supports 206. Holes 202A-F may be reinforced by perimeter flanges 208A-F as appropriate. In an exemplary embodiment, string carrier 110 is made from thermoformed or injection molded plastic, although of course other materials such as cardboard, polyvinyl chloride (PVC) or polyethylene plastic, metal, etc. could be used in alternate embodiments.

In the embodiment shown in FIGS. 2A-C, the narrow end of string 102 is inserted into channel 108 to wind string 102 onto carrier 110. Channel 108 is shown as the space between two perimeter flanges 212 and 210, although in alternate embodiments outer flange 210 may be omitted entirely such that the coiled string is visible when viewed from the radial exterior of string carrier 110. In still other embodiments, channel 108 may be enclosed entirely by a cover spanning flanges 210 and 212. As best shown in FIG. 1, the eyelet or otherwise enlarged end of a string is suitably blocked by inlet 204 and prevented from entering channel 108. The other (narrow) end of string 102 may be received within a hole or gap in inner flange 212 to hold string 102 during winding, as discussed above.

In an exemplary embodiment, the diameter of carrier 110 is on the order of 44.5 inches and the width is on the order of about 0.4-0.6 inches, although of course string carriers of any size could be formulated depending on the type of string being dispensed and other design considerations. If the carrier diameter is too small, the coiled string 102 could develop an undesirable “memory” or curl after being dispensed. If the diameter is too large, the corresponding housing 104 may be too large to fit into the industry-wide standard footprint for instrument string retail display space. Accordingly, a carrier diameter equal to about 20-80% of the package height may be used. The width of string carrier 110 is suitably determined by flanges 210 and 212, by perimeter flanges 208A-F, and by supports 206A-C, which may interface with the back face 220 of another string carrier 110 when stacked within a housing 104 (FIG. 1). Holes 202A-F are shown at sixty-degree intervals in FIG. 2A. By aligning holes 202A-F in six string carriers 110 while simultaneously staggering the locations of opening 204, the ball ends of strings 102A-F can be separated from one another without compromising the overall storage volume available from dispenser 100. In other embodiments, however, holes 202A-F are omitted entirely, reduced or increased in number, and/or located at different positions on carrier 110. Similarly, any number of supports 206A-C may be placed in any position on string carrier 110 in alternate embodiments.

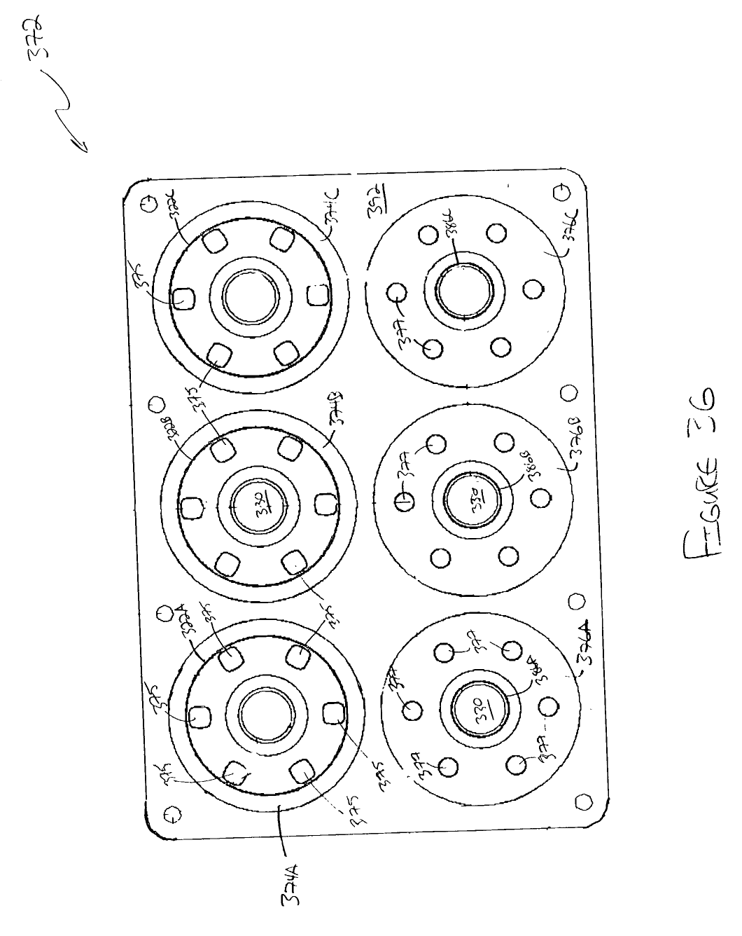

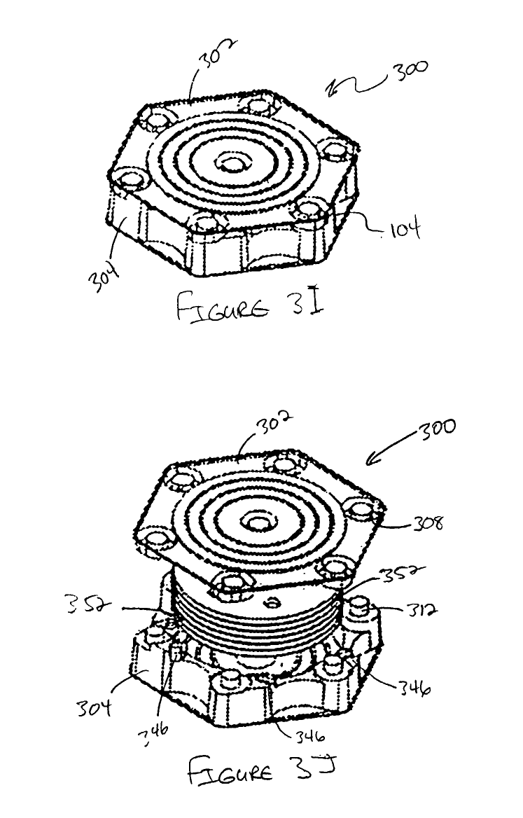

FIGS. 3A-J show various views of a second exemplary embodiment of a string dispenser having rotating string carriers and of the various components thereof. FIGS. 3A-B are side and top views, respectively, of an exemplary cover 302 suitable for use in a string dispenser 300. With reference now to FIGS. 3A-B, an exemplary cover 302 suitably includes a front panel 336 with one or more support receptors 308A-F. Each support receptor 308A-F suitably includes a center hole configured to receive a support post (described below) surrounded by a support wall or flange 342. The perimeter of front panel 336 may be supported by an outer flange 338. In the embodiment shown in FIGS. 3A-B, a central support receptor 310 is included, along with a number of additional support ribs 314 to act as spacers for the string-holding string carriers 320. In an exemplary embodiment, cover 302 is approximately 4.5 inches in diameter and about 0.25 inches thick to accommodate retail displays for string packages, although of course covers of other dimensions could be formulated.

FIGS. 3C-D are side and top views, respectively, of an exemplary base 304. With reference now to FIGS. 3C-D, base 304 suitably includes any number of support posts 312A-F fashioned to mate with receptors 308A-F on cover 302. A central support post 314 may also be provided to mate with receptor 310 on cover 302 and to act as a spindle or hub to string carriers 320, as discussed more fully below. Each of the support posts 312A-F and 314 has an appropriate protrusion sized to be accepted into the holes in receptors 308A-F when string dispenser 300 is assembled. In an exemplary embodiment, support posts 312A-F and 314 have an outer diameter of about 0.5″, and the protrusions have a diameter of about 0.25″, although other dimensions could be used in alternate embodiments. As best seen in FIG. 3D, base 304 may also include one or more ribs 316 to support string carriers 320, and may further have one or more notches, grooves or other recessions 346A-F sized to accept the ball end of a string and to hold the string in place. Each of the strings may be supported at a unique height above the back face 344 of base 304 to reflect that each string 102 is maintained on an individual string carrier 320, to allow “staggering” of the ball ends of the string around the perimeter of package 300, and to facilitate easy individual access to all strings 102 maintained within the package.

FIGS. 3E-F are top and side views, respectively, of an exemplary string carrier 320 suitable for use within string dispenser 300. With reference now to FIGS. 3E-F, an exemplary string carrier 320 suitably includes two face members 374 and 376 joined by a perimeter support 322 creating an outer channel 108 for a string 102. As discussed above in conjunction with FIG. 2, string carrier 320 may include one or more holes 202A-F, each of which may have a perimeter support running between the two face members 382 and 384. Although not shown in FIGS. 3E-F, one or more additional support posts 206A-C may also be provided. A central hole 330 may also be provided with or without a center support 386 running between the two face members 374 and 376 around the perimeter of central hole 330 to accommodate central support 314 of base 304 such that the central support 314 acts as a spindle or hub during rotation. In other embodiments, however, central hole 330 is omitted, and each carrier 320 is held in position by the housing 104 of package 300 and by the other string carriers 320A-F. Similarly, each string carrier 320 may include an additional flange, wall or other structure (not shown in FIG. 3E) on the outer perimeter of carrier 320 to enclose string 102 and/or to assist in holding the string 102 in place after winding. In an exemplary embodiment, each string carrier 320 is approximately 3.5 to 4 inches in diameter. As with string carrier 120 described in FIG. 2, the diameter of each string carrier 320 is typically sized to be about 20-80% of the package height to conform to industry standard footprints for retail string packaging.

In an exemplary embodiment, string carriers 320 are made by joining multiple component parts with an adhesive, plastic weld, mechanical lock or the like. FIG. 3G shows a top view of a layout 372 for pressing three string carriers 320 from a sheet 392 of thermoformed plastic or another appropriate material. With reference now to FIG. 3G, multiple front faces 374 and back faces 376 are formed from a sheet of thermoformed plastic. Each face suitably includes a central hole 330, and may include one or more additional holes 202 (FIG. 3E) as appropriate. In the embodiment shown in FIG. 3G, each front face 374A-C is shown formed with a perimeter supports 322A-C and six male snap-fit details 375. Each back face 376A-C is shown formed with a central support 386 and six female snap-fit details 377 sized to receive the male snap-fit details 375 of front face 374. After being cut out or otherwise removed from sheet 392, each front face 374 is suitably aligned with a back face 376 such that the male snap-fit details 375 mate with the female snap-fit details 377 to hold the two faces 374 and 376 together with a tight tolerance fit. Alternatively or additionally, the two faces 374 and 376 may be joined with an adhesive, plastic weld or the like to form a string carrier 320 as appropriate. String carriers 320 could be formulated according to any scheme using any number of components, and the design details of particular string carriers 320 may vary widely from embodiment to embodiment.

FIGS. 3H-J are side, perspective and exploded perspective views of an exemplary string package/dispenser 300. With reference to FIGS. 3H-J, an exemplary string package 300 suitably includes a base 304 and a cover 302 sandwiching or otherwise holding a stack 352 of carriers 320 in place. Base 304 and cover 302 are appropriately aligned such that the protrusions of support posts 312A-F are received within the holes of receptors 308A-F. The protrusions may be held in place by an epoxy or other adhesive, by a mechanical lock, by friction, or by any other holding technique.

In operation, multiple string carriers 320 are wound with strings 120 of varying diameters before being placed within stack 352 or within the housing of string packaging 300. The wound string carriers 320 may then be placed within base 304. To prevent the string carriers 320 from rotating during shipment, a small piece or tape (such as perforated tape), adhesive or other stabilizing device may be placed between each carrier 320 and base 304 or another part of the dispenser housing. Alternatively, the initial position of each carrier 320 may be fixed with respect to the housing 104 by forming small teeth on the inner diameter of each carrier 320 and on central support post 314 to prevent rotation of carriers 320. The ball end of string 102 is suitably placed within a recession 346 to further hold string 102 in place and to prevent rotation of carrier 320 during shipment. Each of the wound carriers 320 are appropriately placed within the housing such that the ball ends of the strings are staggered at unique radial positions on stack 352 and at a unique height above back face 344 corresponding to the number of string carriers previously placed within base 304. When all of the wound string carriers 320 are placed within the housing, cover 302 is seated on base 304 to hold carriers 320 in place.

To remove a desired string 102, the user simply removes the ball end of the string from recession 346 and pulls on the ball end outwardly from package 300. The force applied by the user appropriately sheers the stabilizing tape, teeth or other structure holding the particular string carrier 320 with the desired string 102 in place, thus freeing carrier 320 to rotate and unwind the string, as appropriate. In a further embodiment, the potential energy stored in the coiled string may be harnessed to assist in dispensing string 102. In such embodiments, the “spring-like” properties of the coiled string 102 can be used to eject a portion of string 102 when the stabilizing tape or other member is broken. Similarly, additional sources of power such as one or more mechanical or electrical micro-motors could be provided to assist in dispensing string 102 from package 300. Various exemplary micro-motors operating on battery-supplied direct current (D.C.) are available from MicroMo Electronics of Clearwater, Fla. and from other sources. Such a motor could be mounted inside housing 104 with a conventional battery to electromechanically dispense string 102 to the user. The motor may be activated by, for example, a button or other switch on the exterior of housing 104 that is actuated by the user. After string 102 is dispensed, it may be fitted on a guitar, piano or other instrument as appropriate.

Of course numerous modifications to package 300 could be made. In particular, the spindle structure provided by central support 314 may be omitted entirely. The physical structure of the various string carriers 320 could be modified dramatically to include an enclosed chamber to hold string 102, for example, or to include a hole, gap or other structure to hold the narrow end of string 102 during winding. The support structures and flanges provided on the string carriers 320 could be modified in any way such that the string carriers 320 create channels 108 of varying widths or depths. Further, the overall dimensions and relative sizes of the package 300 and its associated components will vary widely from component to component. Moreover, it is not necessary that the string carriers 320 be allowed to rotate. In an alternate embodiment to the one shown in FIGS. 3A-J, string carriers 320 may remain fixedly in place such that strings 102 wound about carriers 320 unwind in response to outward force applied by the user. Further, dispenser 300 may be made from any material such as thermoformed plastic or the like.

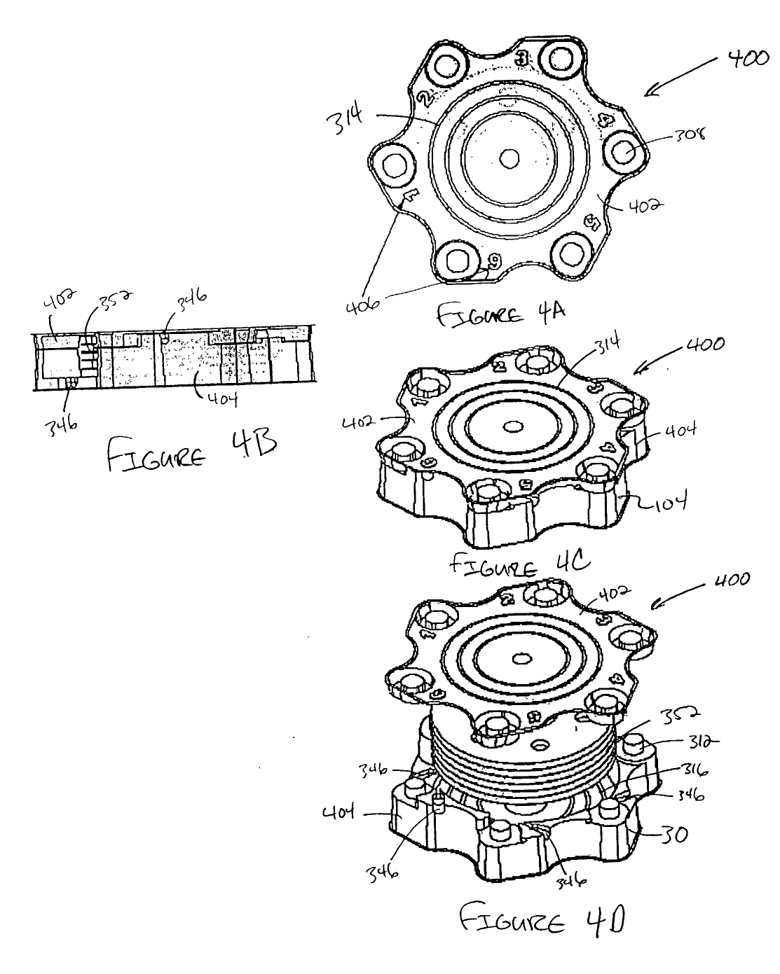

FIGS. 4A-D are top, side, perspective and exploded perspective views, respectively, of another embodiment of a string package/dispenser. With reference to FIGS. 4A-C, an exemplary string dispenser 400 suitably includes a base 404 and a cover 402 creating a housing for a stack 352 of string carriers 320 similar to the embodiment discussed above in conjunction with FIGS. 3A-J. The design of package 400, however, is shown with an appearance similar to that of a bullet-holding cylinder used in a revolver-type pistol. The “cylinder” image is enhanced by incorporating receptors 308 and support posts 312 into the design to appear as “bullet chambers”. Additionally, the scalloped edges provide improved access to recessions 346 so that the user can comfortably remove the ball ends of strings 102 as appropriate. Reference numerals 406 may also be provided on package 400 to identify each string 102 held at a particular position. Numerals 406 (which could alternatively be alphabetic characters, color codes or any other type of identifier) may be placed on package 400 with raised letters in the thermoformed plastic housing, with decals or other emblems, or in any other manner.

As with the previous embodiment, package 400 suitably includes one or more support ribs 314, 316 to support the stack 352 of string carriers 320 within the housing. The various string carriers 320 are formed in any appropriate manner and style to hold a coiled string 102. The ball ends of strings 102 are placed within recessions 346 to hold the string in place during packing and shipment. As described above, the various recessions 346 are shown positioned with approximately sixty degrees of separation from each other such that the ball ends are spaced roughly equidistantly from each other. Recessions 346 are also shown at varying heights above the back face of base 404 to allow each string to be placed on its own string carrier 320.

When each of the string carriers 320 are wound and placed within base 404, cover 402 is suitably attached to base 404 with support posts 312 mating with receptors 308 to hold the stack 352 of string carriers 320 in position. Each of the string carriers 320 is thereafter free to rotate with respect to the other string carriers 320 to unwind string 102 as appropriate. In an alternate embodiment, however, fixed string carriers may be locked in position with respect to the housing.

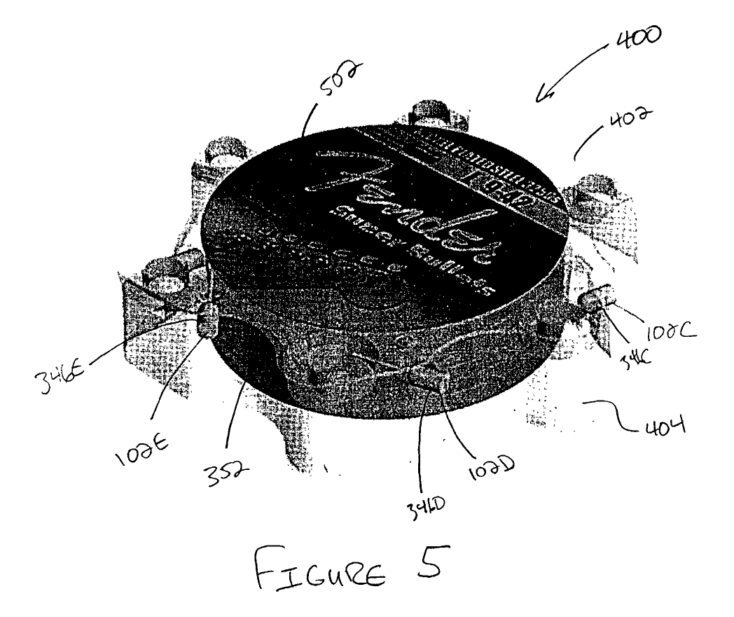

FIG. 5 is a cutaway perspective view of a string package/dispenser 400 as described in FIGS. 4A-D. With reference now to FIG. 5, a string package 400 suitably includes a base 404 and cover 402 enclosing a stack 352 of string carriers 320, each string carrier 320 having a string 102 coiled thereon. The ball ends of strings 102A-F are suitably placed within recessions 346A-F to maintain the strings 102A-F in position. A logo, decal or other design 502 may be further placed on either or both faces of package 400, and the entire package may be shrink-wrapped, enclosed in an outer casing, or otherwise enclosed prior to shipment to further protect strings 102A-F.

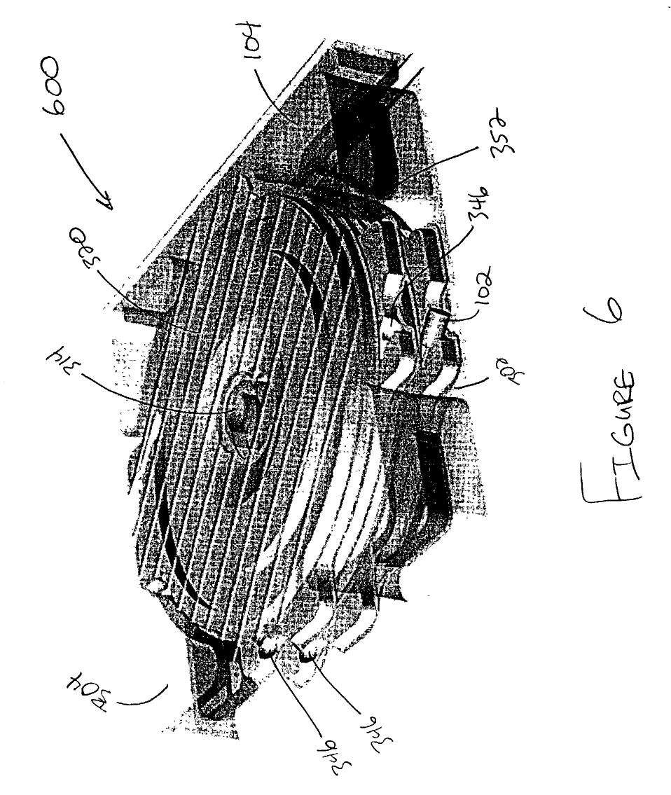

FIG. 6 is a cutaway perspective view of an alternate embodiment of a string packaging device 600. With reference now to FIG. 6, an exemplary string packaging device/dispenser 600 suitably includes a housing 104 enclosing a stack 352 of string carriers 320, as described above. In the embodiment shown in FIG. 6, however, housing 104 is arranged to hold string carriers 320 such that string ends are presented at ninety degree angles from the center of the string carrier 320 and with two strings 102 made available on each of three sides of housing 104. Housing 104 includes a base 304 and a cover 302. Base 302 may be molded or otherwise formed to have a spindle 314 that supports rotation of string carriers 320, or spindle 314 may be omitted in an alternate embodiment. Cover 304 suitably has four side panels that extend around string carrier 352 and that are joined to base 302 with an adhesive, plastic weld, or the like.

Accordingly, several embodiments of a new and useful string packaging device/dispenser are disclosed herein. Various embodiments of the new dispenser exhibit marked improvements over conventional string packaging by maintaining each of the strings on a separate carrier to prevent tangling and to aid in separately identifying each of the strings. Because each instrument typically requires multiple strings of differing diameters (e.g. a conventional guitar typically requires six strings for normal operation), the new packaging provides added convenience to the musician by allowing a single desired string to be readily identified, removed from the packaging, and mounted on the instrument without disturbing the packaging of the other strings.

Numerous equivalents to the exemplary embodiments shown herein may be formulated. Although the embodiments discussed herein typically involve a six string dispenser for conventional acoustic and electric guitar strings, for example, any number of strings could be dispensed by adjusting the number of string carriers/spools in any of the embodiments. Further, each of the embodiments shown herein may be configured with rotable and/or non-rotable string carriers, electromechanical micro-motors, springs or other mechanisms to assist in dispensing strings. Still further embodiments make use of the “spring-like” potential energy stored within the coiled string to aid in ejecting the strings from the package.

For the sake of brevity, conventional manufacturing and mechanical design techniques used in developing various string-dispensing devices (and the various components thereof) are not described in detail herein. Accordingly, packaging devices disclosed herein may be readily modified to create equivalent embodiments through application of general mechanical and industrial principles. Although the embodiments described herein show string packages that are generally cylindrical in shape, for example, other design styles could be formulated. String packages could be readily formulated with round, angular, quadrilateral, oval or other shapes, for example, or with combinations of multiple shapes and structures. In a further embodiment, the string packages may be adorned with an ornamental design, logo, trademark, celebrity likeness or other graphic. Moreover, although the discussion herein has focused primarily on guitar strings, the general principles described herein could be readily adapted to packaging strings for any other musical instruments such as pianos, harpsichords, harps, violins, cellos, bass guitars, mandolins, sitars, ukuleles, banjos and the like.

The particular implementations shown and described herein are examples of the invention and are not intended to otherwise limit the scope of the invention in any way. The connecting lines shown in the various figures contained herein are intended to represent exemplary functional relationships and/or physical couplings between the various elements. It should be noted that many alternative or additional functional relationships and physical connections may be present in a practical string-dispensing device. The corresponding structures, materials, acts and equivalents of all elements in the claims below are intended to include any structure, material or acts for performing the functions in combination with other claimed elements as specifically claimed. The scope of the invention should be determined by the appended claims and their legal equivalents, rather than by the examples given above. No item or component is essential to the practice of the invention unless the element is specifically described herein as “critical”, “essential” or “required”.

What is claimed is:

1. A package for a musical instrument string, the package comprising:
a string carrier having a channel formed thereon configured to receive the string in a coiled manner;
a base configured to receive the string carrier and the coiled string; and
a cover affixed to the base to form a housing about the string carrier such that the string carrier is held in position within the housing and such that at least an end portion of the string is available from outside the housing.

2. The package of claim 1 wherein the string carrier is held by the housing such that the string carrier is free to rotate and to thereby dispense the string.

3. The package of claim 1 wherein the channel is formed by a first flange on the string carrier.

4. The package of claim 3 wherein the string carrier comprises a second flange located radially outward on the string carrier from the first flange and forming an outer wall of the channel.

5. The package of claim 1 wherein the base comprises a recession configured to receive the ball end of the string.

6. The package of claim 1 wherein the base further comprises at least one support in contact with the string carrier and rotably supporting the string carrier within the base.

7. The package of claim 2 wherein the base comprises a plurality of support posts and wherein the cover comprises a plurality of receptors, and wherein each of the support posts mates with one of the receptors to join the cover to the base.

8. The package of claim 7 wherein the base further comprises a spindle, and wherein a central hole in the string carrier is received on the spindle.

9. The package of claim 1 wherein the base comprises a recession configured to accept a ball end of the string when the string carrier is placed within the housing.

10. The package of claim 2 further comprising a second string carrier configured to receive a second string in a coiled manner, and wherein the second string carrier is placed between the first string carrier and the cover.

11. The package of claim 10 wherein both the first and the second string carriers are allowed to rotate with respect to each other and with respect to the cover.

12. The package of claim 1 further comprising a means for dispensing the string to the user.

13. The package of claim 12 wherein the means for dispensing operates using potential energy from the coiled string.

14. The package of claim 12 wherein the means for dispensing comprises a micro-motor.

15. The package of claim 1 further comprising a dispensing motor operatively coupled to the string carrier.

16. The package of claim 15 wherein the dispensing motor comprises a micro-motor.

17. The package of claim 15 wherein the dispensing motor is configured to utilize potential energy stored in the coiled string to dispense the string.

18. A method of packaging a string for a musical instrument, the method comprising the steps of:
winding the string on a string carrier;
placing the string carrier with the wound string in a base portion of a housing;
affixing a cover to the base to maintain the string carrier in position within the housing such that the string carrier is accessible to a user.

19. The method of claim 11 further comprising the step of placing a ball end of the string into a recession in the housing.

20. The method of claim 18 further comprising the steps of:
winding a second string on a second string carrier; and
placing the second string carrier with the second wound string into the housing proximate the first string carrier prior to the, step of affixing the cover to the housing.

21. The method of claim 18 further comprising the step of affixing a logo to the housing.

22. The method of claim 21 further comprising the step of enclosing the housing in shrinkwrap.

23. The method of claim 18 wherein the string carrier is configured to rotate with respect to the housing.

24. The method of claim 23 further comprising the step of placing a stabilizing structure between the string carrier and the housing to temporarily restrict rotation of the string carrier.

25. The method of claim 24 wherein the stabilizing structure comprises tape.

26. The method of claim 24 wherein the stabilizing structure comprises interlocking teeth on the housing and on the string carrier.

27. A package for a set of musical instrument strings, the package comprising:
a plurality of string carriers, each string carrier having a channel configured to receive one of the set of strings in a coiled manner;
a base configured to receive the plurality of string carriers and the coiled strings; and
a cover affixed to the base to form a housing about the plurality of string carriers such that the string carriers are held in position within the housing and such that at least an end portion of each string is available from outside the housing.

28. The package of claim 27 wherein the plurality of string carriers is held by the housing such that each string carrier is free to rotate and to thereby dispense one of the set of strings.

29. The package of claim 27 wherein the base comprises a plurality of recessions formed therein, one recession for each of the strings, whereby each recessions is configured to retain an end of one of the strings.

30. The package of claim 28 wherein each of the recessions are supported at a unique distance from a back face of the base.

31. The package of claim 27 wherein the package is comprised of thermoformed plastic.
